(19) United States
(12) Patent Application Publication
(10) Pub. No.: US 2024/0352250 A1
(43) Pub. Date: Oct. 24, 2024

(54) PLASTICIZED BIOPOLYMER COMPOSITIONS AND METHODS OF MAKING THEREOF

(71) Applicant: Ohio State Innovation Foundation, Columbus, OH (US)

(72) Inventors: Yael VODOVOTZ, Worthington, OH (US); Xiaoying ZHAO, Beijing (CN); Emmanouil CHATZAKIS, Hilliard, OH (US); Kathryn WILLIAMSON, Lausanne (CH)

(21) Appl. No.: 18/687,973

(22) PCT Filed: Aug. 30, 2022
(86) PCT No.: PCT/US22/41955

§ 371 Date: Feb. 29, 2024

Related U.S. Application Data
(60) Provisional application No. 63/239,622, filed on Sep. 1, 2021.

(51) Int. Cl. C08L 67/04; C08L 91/00

(52) U.S. Cl. CPC C08L 67/04; C08L 91/00; C08L 2201/06

(57) ABSTRACT

Disclosed herein are plasticized biopolymer compositions and methods of making thereof. For example, disclosed herein are compositions comprising: a biopolymer and a plasticizer; wherein the plasticizer comprises an epoxidized biomass oil; wherein the epoxidized biomass oil comprises an oil extracted from a biomass, which is an extracted biomass oil, and wherein said extracted biomass oil has been epoxidized; wherein the biomass comprises food waste, coffee beans, or a combination thereof; and wherein the plasticizer is present in an amount of from 0.1 to 50% by weight (wt. %), based on the total weight of the composition.

### CROSS-REFERENCE TO RELATED APPLICATIONS

This application claims the benefit of priority to U.S. Provisional Application No. 63/239,622, filed Sep. 1, 2021, which is hereby incorporated herein by reference in its entirety.

### BACKGROUND

Bioplastics are promising due to their renewable and biodegradable properties but are brittle and difficult to process due to their molecular characteristics, limiting their industrial applications. Efforts have been made to overcome the shortcomings of bioplastics; however further improvements are still needed. The compositions, methods, and systems discussed herein addresses these and other needs.

### SUMMARY

In accordance with the purposes of the disclosed compositions, methods, and systems as embodied and broadly described herein, the disclosed subject matter relates to plasticized biopolymer compositions and methods of making thereof.

Additional advantages of the disclosed compositions, systems, and methods will be set forth in part in the description which follows, and in part will be obvious from the description. The advantages of the disclosed compositions, systems, and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Schematic of developing bio-based plasticizers using oil extracted from spent coffee oil.

FIG. 2. Image of CEM EDGE extractor.

FIG. 3. Image of spent coffee ground (SCG) oil extract.

FIG. 4. Image of epoxidized SCG oil.

FIG. 5. Image of unplasticized PHBV (poor processability).

FIG. 6. Image of 0.5% coffee epoxide plasticized PHBV.

FIG. 7. Image of 3% soybean oil epoxide plasticized PHBV.

### DETAILED DESCRIPTION

The compositions, methods, and systems described herein may be understood more readily by reference to the following detailed description of specific aspects of the disclosed subject matter and the Examples included therein.

Before the present compositions, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

### General Definitions

In this specification and in the claims that follow, reference will be made to a number of terms, which shall be defined to have the following meanings.

Throughout the description and claims of this specification the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

Values can be expressed herein as an “average” value. “Average” generally refers to the statistical mean value.

By “substantially” is meant within 5%, e.g., within 4%, 3%, 2%, or 1%.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

The prefix “bio-” is used herein to designate a material that has been derived from a renewable resource.

The term “renewable resource” refers to a resource that is produced by a natural process at a rate comparable to its rate of consumption (e.g., within a 100-year time frame). The resource can be replenished naturally, or via agricultural techniques.

The term “biobased content” refers to the percent by weight of a material that is composed of biological products or renewable agricultural materials or forestry materials or an intermediate feedstock.

The term “biodegradable” refers to a composite or product capable of being broken down (e.g. metabolized and/or hydrolyzed) by the action of naturally occurring microorganisms, such as fungi and bacteria.

The term “compostable” or “industrially compostable” refers to a composite or product that satisfies requirement, set by ASTM D6868-03.

As used herein, “molecular weight” refers to number average molecular weight as measured by ¹H NMR spectroscopy, unless indicated otherwise.

“Polymer” means a material formed by polymerizing one or more monomers.

The term “(co)polymer” includes homopolymers, copolymers, or mixtures thereof.

The term “(meth)acryl . . . ” includes “acryl . . . ,” “methacryl . . . ,” or mixtures thereof.

### Compositions

Disclosed herein are plasticized biopolymer compositions and methods of making thereof. For example, disclosed herein are compositions comprising a biopolymer and a plasticizer.

The biopolymer can comprise any suitable biopolymer. In some examples, the biopolymer comprises a biopolyester. In some examples, the biopolymer comprises a polyhydroxyalkanoate polymer. In some examples, the biopolymer comprises a (co)polymer of one or more monomers selected from lactic acid, 3-hydroxypropionate, 3-hydroxybutyrate, 4-hydroxybutyrate, 4-hydroxyvalerate, 5-hydroxyvalerate, 3-hydroxyhexanoate, 6-hydroxyhexanoate, and 3-hydroxyoctanoate. In some examples, the biopolymer comprises polylactic acid (PLA), poly(3-hydroxybutyrate-co-3-hydroxyvalerate) (PHBV), cellulose, starch-based bioplastics, derivatives thereof, or combinations thereof. In some examples, the biopolymer comprises cellulose or derivatives thereof, such as cellulose esters.

The plasticizer comprises an epoxidized biomass oil. The epoxidized biomass oil comprises an oil extracted from a biomass (e.g., an extracted biomass oil) that has been epoxidized.

The term “biomass,” as used herein, refers to living or dead biological material that can be used in one or more of the disclosed compositions or methods. In the disclosed compositions and methods, the “biomass” can comprise food waste, coffee beans, or a combination thereof; The term “food waste” as used herein includes, but is not limited to, any food or an inedible part of food removed from the food supply chain at any point such that it is not consumed by a human and/or animal. The term “coffee bean” as used herein includes the seeds of a Coffea species in any form. For example, the coffee beans can comprise green coffee beans, roasted coffee beans, spent coffee grounds, or a combination thereof.

In some examples, the biomass comprises coffee beans. In some examples, the coffee beans comprise green coffee beans, roasted coffee beans, spent coffee grounds, or a combination thereof. In some examples, the biomass comprises spent coffee grounds (e.g., ground coffee beans generated after a coffee beverage has been brewed from said ground coffee beans).

The plasticizer can, for example, be present in an amount of 0.1% by weight (wt. %) or more, based on the total weight of the composition (e.g., 0.2 wt. % or more, 0.3 wt. % or more, 0.4 wt. % or more, 0.5 wt. % or more, 0.75 wt. % or more, 1 wt. % or more, 1.25 wt. % or more, 1.5 wt. % or more, 1.75 wt. % or more, 2 wt. % or more, 2.25 wt. % or more, 2.5 wt. % or more, 2.75 wt. % or more, 3 wt. % or more, 3.25 wt. % or more, 3.5 wt. % or more, 3.75 wt. % or more, 4 wt. % or more, 4.25 wt. % or more, 4.5 wt. % or more, 4.75 wt. % or more, 5 wt. % or more, 5.5 wt. % or more, 6 wt. % or more, 6.5 wt. % or more, 7 wt. % or more, 7.5 wt. % or more, 8 wt. % or more, 8.5 wt. % or more, 9 wt. % or more, 9.5 wt. % or more, 10 wt. % or more, 11 wt. % or more, 12 wt. % or more, 13 wt. % or more, 14 wt. % or more, 15 wt. % or more, 20 wt. % or more, 25 wt. % or more, 30 wt. % or more, 35 wt. % or more, 40 wt. % or more, or 45 wt. % or more). In some examples, the plasticizer can be present in an amount of 50 et. % or less, based on the total weight of the composition (e.g., 45 wt. % or less, 40 wt. % or less, 35 wt. % or less, 30 wt. % or less, 25 wt. % or less, 20 wt. % or less, 15 wt. % or less, 14 wt. % or less, 13 wt. % or less, 12 wt. % or less, 11 wt. % or less, 10 wt. % or less, 9.5 wt. % or less, 9 wt. % or less, 8.5 wt. % or less, 8 wt. % or less, 7.5 wt. % or less, 7 wt. % or less, 6.5 wt. % or less, 6 wt. % or less, 5.5 wt. % or less, 5 wt. % or less, 4.75 wt. % or less, 4.5 wt. % or less, 4.25 wt. % or less, 4 wt. % or less, 3.75 wt. % or less, 3.5 wt. % or less, 3.25 wt. % or less, 3 wt. % or less, 2.75 wt. % or less, 2.5 wt. % or less, 2.25 wt. % or less, 2 wt. % or less, 1.75 wt. % or less, 1.5 wt. % or less, 1.25 wt. % or less, 1 wt. % or less, 0.75 wt. % or less, 0.5 wt. % or less, 0.4 wt. % or less, 0.3 wt. % or less, or 0.2 wt. % or less). The amount of plasticizer can range from any of the minimum values described above to any of the maximum values described above. For example, the plasticizer can be present in an amount of from 0.1 to 50% by weight (wt. %), based on the total weight of the composition (e.g., from 0.1 wt. % to 25 wt. %, from 25 wt. % to 50 wt. %, from 0.1 wt. % to 10 wt. %, from 10 wt. % to 20 wt. %, from 20 wt. % to 30 wt. %, from 30 wt. % to 40 wt. %, from 40 wt. % to 50 wt. %, from 0.1 wt. % to 45 wt. %, from 0.5 wt. % to 50 wt. %, from 0.5 wt. % to 45 wt. %, from 0.1 wt. % to 40 wt. %, from 0.1 wt. % to 20 wt. %, from 0.1 wt. % to 5 wt. %, from 0.1 wt. % to 2.5 wt. %, from 0.1 wt. % to 1 wt. %, or from 0.5 wt. % to 1 wt. %).

In some examples, the composition has a flexural modulus, the biopolymer has a flexural modulus in the absence of the plasticizer, and the flexural modulus of the composition is less than the flexural modulus of the biopolymer in the absence of the plasticizer (e.g., the composition has a flexibility that is greater than the flexibility of the biopolymer in the absence of the plasticizer). The flexural modulus can be measured, for example, according to the standard method described in ASTM D790-17. In some examples, the flexural modulus of the composition is 25% or more of the flexural modulus of the biopolymer in the absence of the plasticizer (e.g., 30% or more, 35% or more, 40% or more, 45% or more, 50% or more, 55% or more, 60% or more, 65% or more, 70% or more, 75% or more, 80% or more, or 85% or more). In some examples, the flexural modulus of the composition is 90% or less of the flexural modulus of the biopolymer in the absence of the plasticizer (e.g., 85% or less, 80% or less, 75% or less, 70% or less, 65% or less, 60% or less, 55% or less, 50% or less, 45% or less, 40% or less, 35% or less, or 30% or less). The flexural modulus of the composition can range from any of the minimum values described above to any of the maximum values described above relative to the flexural modulus of the biopolymer in the absence of the plasticizer. For example, the flexural modulus of the composition can be from 25% to 90% of the flexural modulus of the biopolymer in the absence of the plasticizer (e.g., from 25% to 60%, from 60% to 90%, from 25% to 50%, from 50% to 75%, from 75% to 90%, from 20% to 90%, from 25% to 85%, or from 30% to 85%).

In some examples, the composition has a tensile strength, the biopolymer has a tensile strength in the absence of the plasticizer, and the tensile strength of the composition is improved relative to the tensile strength of the biopolymer in the absence of the plasticizer.

In some examples, the composition has a tensile elongation, the biopolymer has a tensile elongation in the absence of the plasticizer, and the tensile elongation of the composition is improved relative to the tensile elongation of the biopolymer in the absence of the plasticizer.

### Methods

Also disclosed herein are methods of making any of the compositions disclosed herein. The methods can, for example, comprise contacting the biopolymer with the plasticizer. In some examples, the plasticizer can be mixed with the biopolymer. In some examples, the method comprises reactively extruding a mixture comprising the biopolymer and the plasticizer.

In some examples, the methods further comprise making the epoxidized biomass oil by epoxidizing the extracted biomass oil. Any suitable epoxidation method can be used, such as those known in the art (e.g., epoxidation using peracids, hydrogen peroxide, dioxirane, phase transfer catalyst, etc.). In some examples, epoxidizing the extracted biomass oil comprises contacting the extracted biomass oil with an acid and a peroxide, such as formic acid and hydrogen peroxide.

In some examples, the methods can further comprise extracting the oil from the biomass. Any suitable extraction method can be used, such as those known in the art. In some examples, extracting the oil from the biomass comprises solid phase extraction, liquid-liquid extraction, pressurized fluid extraction, supercritical fluid extraction, mechanical pressing (e.g., cold-pressing), steam distillation, or a combination thereof. In some examples, extracting the oil from the biomass comprises contacting the biomass with supercritical CO₂.

The amount of oil extracted from the biomass can, for example, be 10 wt. % or more based on the total weight of the biomass prior to the extraction (e.g., 11 wt. % or more, 12 wt. % or more, 13 wt. % or more, 14 wt. % or more, 15 wt. % or more, 16 wt. % or more, 17 wt. % or more, 18 wt. % or more, or 19 wt. % or more). In some examples, the amount of oil extracted from the biomass can be 20 wt. % or less based on the total weight of the biomass prior to the extraction (e.g., 19 wt. % or less, 18 wt. % or less, 17 wt. % or less, 16 wt. % or less, 15 wt. % or less, 14 wt. % or less, 13 wt. % or less, 12 wt. % or less, or 11 wt. % or less). The amount of oil extracted from the biomass can range from any of the minimum values described above to any of the maximum values described above. For example, the amount of oil extracted from the biomass can be from 10 to 20 wt. % based on the total weight of the biomass prior to the extraction (e.g., from 10 wt. % to 15 wt. %, from 15 wt. % to 20 wt. %, from 10 wt. % to 12 wt. %, from 12 wt. % to 14 wt. %, from 14 wt. % to 16 wt. %, from 16 wt. % to 18 wt. %, from 18 wt. % to 20 wt. %, from 11 wt. % to 20 wt. %, from 10 wt. % to 19 wt. %, from 11 wt. % to 19 wt. %, from 10 wt. % to 18 wt. %, from 10 wt. % to 16 wt. %, or from 12 wt. % to 14 wt. %).

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1—Development of Bio-Based Plasticizers Utilizing Oil Extracted from Spent Coffee Grounds

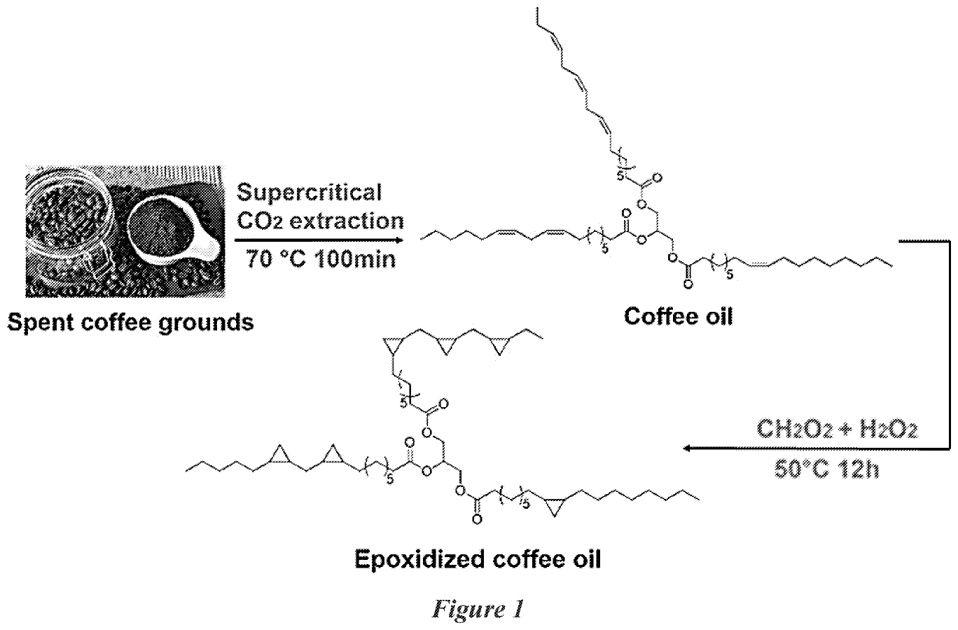

Proposed herein is the development of bio-based plasticizers by value-added use of oil extracted from spent coffee grounds (SCG), the organic residues from brewed coffee (FIG. 1).

Coffee is among the most traded and consumed commodities in the world. Around eight million tons of coffee is consumed globally each year, generating a large amount of SCG, which require a good waste management plan (Caetano N S et al. Clean Technologies and Environmental Policy 2014, 16 (7), 1423-1430). SCG has ˜10-15 wt. % of oil, which is rich in unsaturated fatty acids with double bonds that enable it to undergo various chemical transformations producing low molecular weight polymeric materials with versatile applications, particularly as chief ingredients in coatings (Alam M et al. Arabian Journal of Chemistry 2014, 7 (4), 469-479). The leftover SCG after oil extraction have been used to produce biofuels, biopolymers, antioxidants, and biocomposites (Karmee S K. Waste management 2018, 72, 240-254).

It is hypothesized that SCG oil can be used to produce lipid epoxides (at an efficiency of 95%) by converting its double bonds into epoxy rings through epoxidation (Williamson K et al. Food Research International 2019, 119, 683-692). The epoxidized coffee oil can be used as a plasticizer for polylactic acid (PLA), poly(3-hydroxybutyrate-co-3-hydroxyvalerate) (PHBV), and other bioplastics.

Currently, most of bio-based/biodegradable coatings are derived from chitosan, starch, cellulose, whey/soy proteins, PLA, PHBV, and other renewable materials (Rastogi V K et al. Coatings 2015, 5 (4), 887-930). Research on developing bio-based epoxy and polyurethane coatings from vegetable oils, such as linseed, soybean, cannabis, rapeseed, and maize oils, have been reported (Alam M et al. Arabian Journal of Chemistry 2014, 7 (4), 469-479). The outstanding feature of vegetable oils, i.e., their unique chemical structure with unsaturation sites, hydroxyls, esters, and inherent fluidity, make them “greener” precursors to environment friendly coatings. For example, the presence of ester bonds on the vegetable oils make the obtained epoxy/polyurethane coatings prone to microbial degradation via enzymatic hydrolysis, which is desirable for packaging applications where biodegradability is preferred (Das C K., Thermoplastic Elastomers: Synthesis and Applications. BoD-Books on Demand: 2015). Epoxidation of vegetable oil using peracids, hydrogen peroxide, dioxirane, phase transfer catalyst, and other techniques has been widely studied (Alam M et al. Arabian Journal of Chemistry 2014, 7 (4), 469-479).

This work differs from previous efforts in that the bio-based plasticizers will be developed by value-added use of oil extracted spent coffee grounds, which helps circumvent the food-competition issue of using vegetable oils as coating feedstocks.

The bio-based plasticizers described herein can contribute to CO₂ emission reduction, as the precursors will be based on renewable materials. Advantages of the plasticizers will also include cost reduction, by utilizing food processing waste which supports cost-competitiveness.

The goal of this study is to produce bio-based plasticizers with value-added use of oils extracted from spent coffee grounds, as follows:
a) Oil extraction from spent coffee ground: Lipids from spent coffee grounds will be extracted using supercritical CO₂ (Karmee S K. Waste management 2018, 72, 240-254).

b) Oil conversion into epoxide: The obtained lipids will be converted into multifunctional epoxides through epoxidation with formic acid and hydrogen peroxide as described previously (Karmee S K. Waste management 2018, 72, 240-254).

Mechanical/physical performance, including flexibility and hardness, of the polymers including the plasticizer will be measured according to ASTM D2794 and D3363, respectively. Thermal properties including melting, glass transition, and degradation temperatures will be tested using differential scanning calorimetry (DSC) and thermogravimetric analysis (TGA). Viscosity will be tested using a rheometer and adjusted to match the viscosity required for roll-to-roll coating. Moisture and oxygen barriers will be tested using a dynamic vapor sorption instrument and a MOCON oxygen permeability tester, respectively.

### Example 2

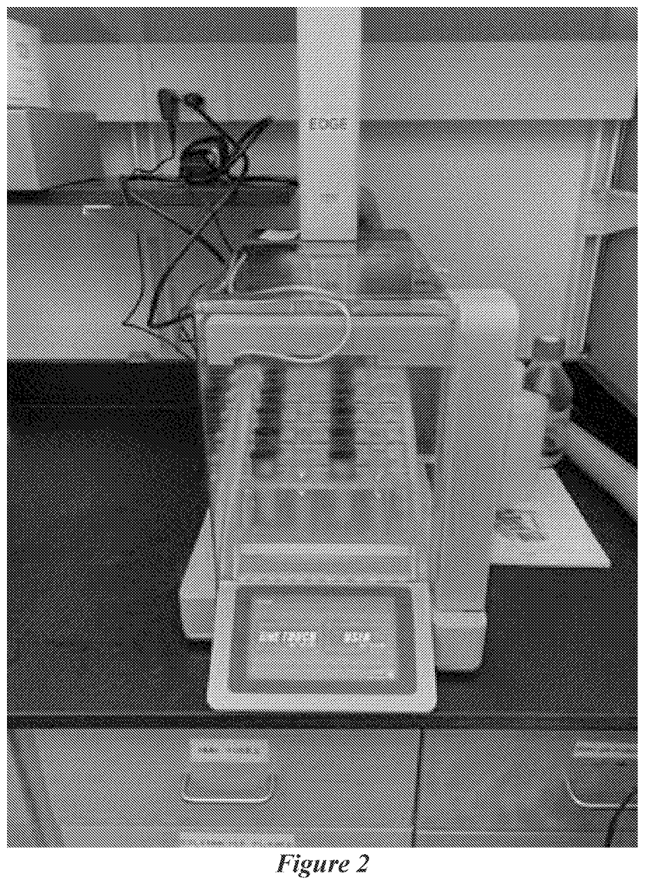

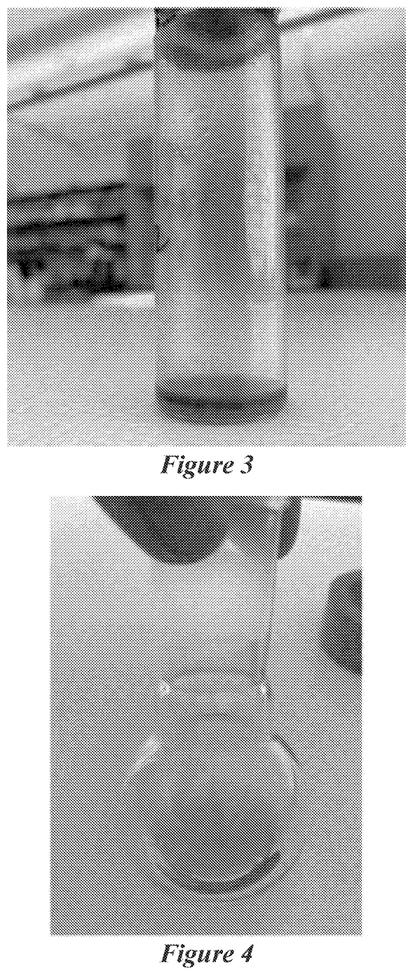

Oil was extracted from spent coffee grounds using a CEM EDGE extractor (FIG. 2). About 100 grams of coffee can be extracted per run. The oil yield of the spent coffee grounds was between 12% and 14%. An image of the oil extracted from spent coffee grounds in shown in FIG. 3.

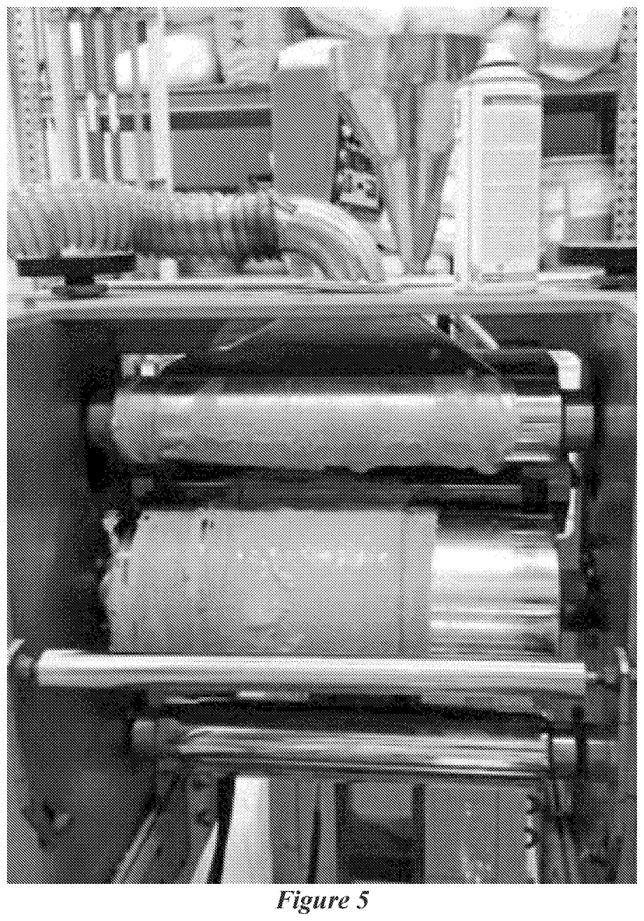

The extracted coffee oil was then epoxidized with hydrogen peroxide (H₂O₂) and formic acid (HCOOH) for at least 12 hours (1.0:2.0:12, coffee oil:formic acid:H₂O₂, molar ratio). An image of the epoxidized SCG oil is shown in FIG. 4.

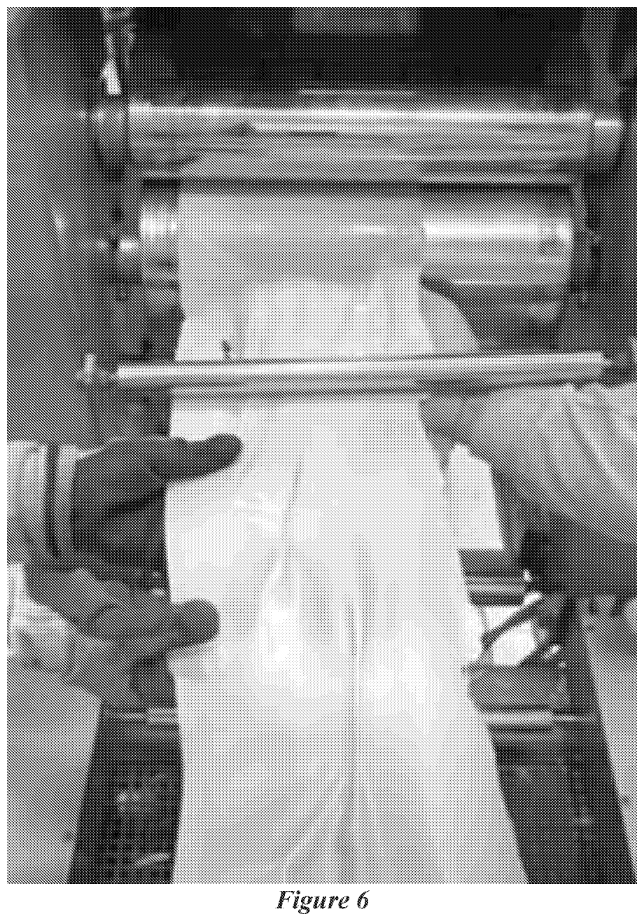

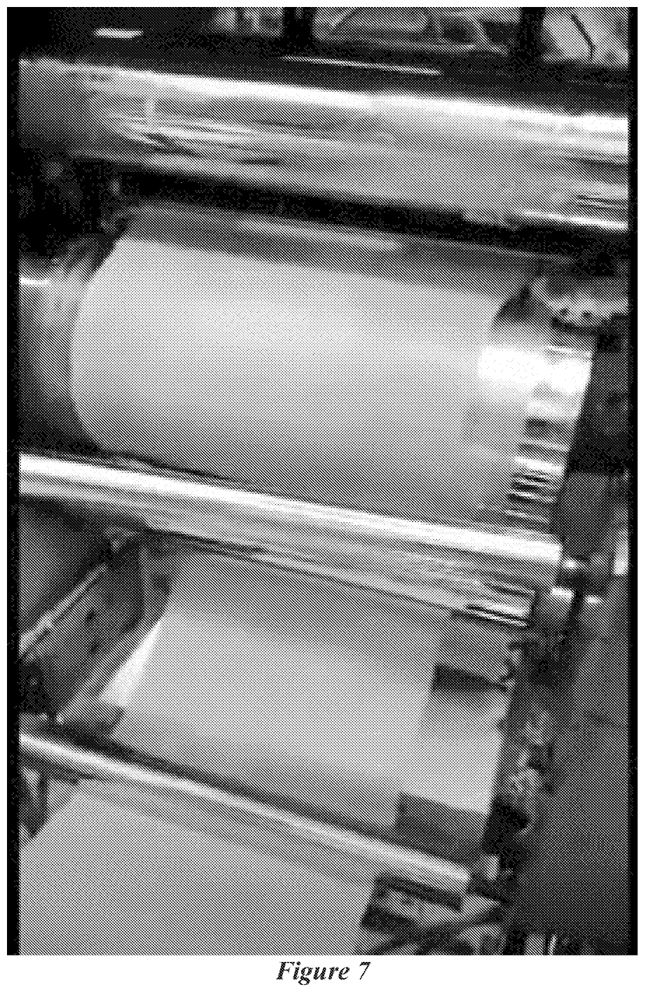

The epoxidized SCG oil was then combined with PHBV. Unplasticized PHBV has poor processability (FIG. 5). The epoxidized SCG oil was highly efficient in improving PHBV processability (FIG. 5-FIG. 7). Specifically, the PHBV was processable with the addition of only 0.5% of the epoxidized coffee oil as a plasticizer (FIG. 6), which is significantly less than the 3% epoxidized soybean oil typically used (FIG. 7).

### Example 3

The use of biobased epoxidized coffee oil as an efficient plasticizing agent for bioplastic materials is disclosed herein.

A biobased epoxy resin was created from the oil extracted from spent coffee grounds (SCG); a waste generated following coffee beverage brewing. SCG oil was extracted and then epoxidized using acid and peroxide, such as formic acid and hydrogen peroxide, at defined conditions (e.g., 50° C. for 12 hours) to obtain epoxidized coffee oil (ECO). The epoxidized coffee oil was used to plasticize bioplastic materials, such as poly(3-hydroxybutyrate-co-3-hydroxyvalerate) (PHBV) and its blends with natural rubber during extrusion. The epoxidized coffee oil (0.5-1 wt. %) was pre-mixed with PHBV bioplastics and conditions for a specific period prior to extrusion to obtain its optimal plasticizing efficiency.

Bioplastics such as PHBV are promising due to their renewable and biodegradable properties but are brittle and difficult to process due to their molecular characteristics, limiting their industrial applications. The epoxidized coffee oil provide to be efficient in plasticizing PHBV bioplastic and had at least two times higher plasticization efficiency than epoxidized soybean oil, a commercially available and commonly used plasticizer. The epoxidized coffee oil was also efficient in improving PHBV flexibility at a loading as low as 0.5%. Value-added use of spent coffee ground to create these epoxides offers a cheap source for polymer plasticizer production. It can also help address the controversy over the competition between food, feed and bioplastics cause by the used of epoxidized vegetable oil.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1. A composition comprising:
a biopolymer; and
a plasticizer;
wherein the plasticizer comprises an epoxidized biomass oil;
wherein the epoxidized biomass oil comprises an oil extracted from a biomass, which is an extracted biomass oil, and wherein said extracted biomass oil has been epoxidized;
wherein the biomass comprises food waste, coffee beans, or a combination thereof, and
wherein the plasticizer is present in an amount of from 0.1 to 50% by weight (wt. %), based on the total weight of the composition.

2. The composition of claim 1, wherein the biopolymer comprises a biopolyester.

3. The composition of claim 1, wherein the biopolymer comprises a polyhydroxyalkanoate polymer.

4. The composition of claim 1, wherein the biopolymer comprises a (co)polymer of one or more monomers selected from lactic acid, 3-hydroxypropionate, 3-hydroxybutyrate, 4-hydroxybutyrate, 4-hydroxyvalerate, 5-hydroxyvalerate, 3-hydroxyhexanoate, 6-hydroxyhexanoate, and 3-hydroxyoctanoate.

5. The composition of claim 1, wherein the biopolymer comprises polylactic acid (PLA), poly(3-hydroxybutyrate-co-3-hydroxyvalerate) (PHBV), cellulose, starch-based bioplastics, derivatives thereof, or combinations thereof.

6. The composition of claim 1, wherein the biomass comprises coffee beans.

7. The composition of claim 6, wherein the coffee beans comprise green coffee beans, roasted coffee beans, spent coffee grounds, or a combination thereof.

8. The composition of claim 1, wherein the biomass comprises spent coffee grounds.

9. The composition of claim 1, wherein the plasticizer is present in an amount of from 0.1 wt. % to 10 wt. % based on the total weight of the composition.

10. The composition of claim 1, wherein the composition has a flexural modulus, the biopolymer has a flexural modulus in the absence of the plasticizer, and the flexural modulus of the composition is less than the flexural modulus of the biopolymer in the absence of the plasticizer.

11. The composition of claim 10, wherein the flexural modulus of the composition is from 25% to 90% of the flexural modulus of the biopolymer in the absence of the plasticizer.

12. The composition of claim 1, wherein the composition has a tensile strength, the biopolymer has a tensile strength in the absence of the plasticizer, and the tensile strength of the composition is improved relative to the tensile strength of the biopolymer in the absence of the plasticizer.

13. The composition of claim 1, wherein the composition has a tensile elongation, the biopolymer has a tensile elongation in the absence of the plasticizer, and the tensile elongation of the composition is improved relative to the tensile elongation of the biopolymer in the absence of the plasticizer.

14. A method of making the composition of claim 1, the method comprising contacting the biopolymer with the plasticizer.

15. The method of claim 14, wherein the method comprises reactively extruding a mixture comprising the biopolymer and the plasticizer.

16. The method of claim 14, wherein the method further comprises making the epoxidized biomass oil by epoxidizing the extracted biomass oil.

17. The method of claim 16, wherein epoxidizing the extracted biomass oil comprises contacting the extracted biomass oil with an acid and a peroxide.

18. (canceled)

19. The method of claim 16, wherein the method further comprises extracting the oil from the biomass.

20. The method of claim 19, wherein the amount of oil extracted from the biomass is from 10 to 20 wt. % based on the total weight of the biomass prior to the extraction.

21. (canceled)

22. The method of claim 19, wherein extracting the oil from the biomass comprises solid phase extraction, liquid-liquid extraction, pressurized fluid extraction, supercritical fluid extraction, mechanical pressing, cold-pressing, steam distillation, or a combination thereof.

23. (canceled)
